(19) United States
(12) Patent Application Publication
(10) Pub. No.: US 2012/0019641 A1
(43) Pub. Date: Jan. 26, 2012

(54) Portable Multifunctional Multimedia Device for Personal Services Industry and Mounting System and Methods of Use

(76) Inventor: Kenneth Mark Reeder, III, Norristown, PA (US)

(21) Appl. No.: 13/175,944

(22) Filed: Jul. 4, 2011

Related U.S. Application Data
(60) Provisional application No. 61/400,315, filed on Jul. 26, 2010.

(51) Int. Cl. H04N 7/18; H01F 7/02; F16M 13/00; F16B 2/20; F16B 47/00

(52) U.S. Cl. 348/61; 248/231.81; 248/206.2; 248/288.11; 248/206.5; 348/E07.085

(57) ABSTRACT

A novel portable multimedia device for improving client experiences in a personal services industry can be detachably mounted to a tool used by the service provider, such as a hair clipper for a barber. The device comprises a processor, data storage, memory, video display and speakers, as well as a data input module, and can accommodate a library of electronic media files. Optionally, the device can include a camera, telephone, GPS, and other functions including credit card processing and bar code reader. Also provided are methods of using the device for professional service providers, for example barbers, hairstylists, or others. Also provided is a universal mounting system for portable electronic devices that comprises a retaining member and a mounting member for mounting to a variety of mounts including handles, clips, suction cups, goosenecks, flexible joints, magnetic mounts, and key rings.

### CROSS-REFERENCE TO RELATED APPLICATIONS

This claims benefit of U.S. Provisional Patent Application No. 61/400,315 filed Jul. 26, 2010, the entirety of which is incorporated herein by reference.

### BACKGROUND

1. Field of the Invention

This relates generally to portable digital devices for use in the personal services industries, and to a mounting system for mounting digital devices in convenient ways, as well as to methods for managing personal services businesses and improving the experience of a client receiving personal services via improved contact with clients using portable multimedia digital electronics and personal preferences, data and/or other information generally provided by the client.

2. Description of Related Art

The increased use of automation in commerce has made customer service less personal, more remote, and more automated, for a more detached customer experience. Yet, there are many professions and businesses which continue to require and/or thrive on direct contact, often in-person contact, including hands-on contact with their clients. Examples of such professions or businesses include hair stylists, barbers, shampoo technicians, manicurists, estheticians and other skin care professionals, nail artists and technicians, electrologists, as well as pedicurists, make-up and eye-brow technicians, masseuses, and tattoo artists, as well as doctors, veterinarians, chiropractic practitioners, nurse practitioners, and midwives and the like. Other examples include teachers, educators, coaches, personal trainers, and the like. Still other services include pet/animal groomers, shoe shiners, tour guides, escorts, valets, and chauffeurs. Thus, personal services businesses for purposes of this disclosure generally involve close customer interactions with the business or the professional, and in many cases direct in-person contact with clients.

Many such personal services industries are populated by small, independent businesses, for example spas, salons, boutiques, barbershops and other small businesses, while others feature mobile locations (e.g. pet/animal grooming) or even in-home services. These businesses generally seek to offer one or more personal services in a manner to encourage repeat customers and/or clients. Depending on the business and the services offered, the clients have different service needs, different requirements, different personal interests, and varying frequency of visiting the service provider or requiring the personal services.

As one example of a personal services industry, the haircutting industry features many small barbershops and salons. In some cases one or more of the professionals (i.e. service providers) may provides services at multiple shops. For example, a barber who owns his own barbershop but is a sole practitioner, may allow one or more additional licensed barbers or stylists to ‘lease’ a chair (or a “station”) in his shop on one or more days per week. The leasing barber, who does not own a shop may lease stations in different barbershops on different days or at different times, and may have his own clientele who seek his services. Similarly a popular hair stylist may rent a station in one or more salons to service her clients in different locations.

As with other personal services industries, of great importance to the hair-cutting industry are individual interactions between the service provider (e.g. a barber or stylist) and the clients (e.g. customers). Not only does the personal service aspect of the business improve the experience for the client, but the barber's, stylist's, or technician's income are greatly influenced by the personalization of the services. Thus clients generally appreciate the personal aspect of the service and are more likely to become regular or repeat customers. In addition, clients who enjoy the personal service received will be more likely to provide a gratuity to show their appreciation. However, while some clients (e.g. “regulars”) may visit the business regularly, for example weekly, others require or desire the available services much less frequently and may come biweekly, monthly, or even less frequently. It is therefore difficult for the barber (or stylist or technician) to know each client personally, so as to be able to readily recall the customer's name, preferences or requirements for hairstyle, family relationships and/or family members' names, pets, personal interests (e.g. hobbies, sports, activities, etc), and other items that will allow the service provider to personalize each client's visits, and to make each client feel appreciated and welcome.

Traditionally, a personal services provider, (for example in the haircutting or styling industry) may have kept his customer or client contact information mentally, or perhaps in paper form, however, such information is hard to memorize, difficult to keep updated, and even more difficult to access in a timely fashion. Currently, a business owner or professional providing such services may use a personal computer to store client data such as those discussed above to facilitate improved client interactions. However, while a personal computer may be useful for storing such data, it is not convenient to access those data when a customer walks in to the barbershop or salon, particularly if unscheduled, unexpected, and/or unannounced.

An alternative is to store such information on a cell phone, particularly a smart phone, such as a service provider's (e.g. a barber's, hairstylist's, or technician's) personal cell phone. However, some clients feel uncomfortable calling their service provider's personal phones (e.g. cell phones), and many barbers and hairstylists are understandably resistant to including clients' personal information, photographs, and other client information on their personal cell phones.

There is therefore a need for improved methods and devices for storing managing and accessing client information to allow more personalized service for small businesses in the hair cutting and other personal services industries.

### SUMMARY

A portable multimedia device is provided for the personal service industry, along with methods for its use in, for example, improving the client experience and/or improving relationships between a professional service provider and his or her clients. The device is applicable to any personal service administered by a service provider to a client and is exemplified for applications in the hair cutting industry. The multimedia device is a computer product having a variety of functions for the professional (e.g. barber, hair stylist, groomer, or other personal services professional) and allows improved client relationships, improved client experience, increase client enjoyment, and/or other functions. The device provides a client management function and access to a multimedia library that is cross-referenced to the clients based, for example on their hair style preferences or other interests.

Thus, in one of the several aspects of this disclosure, the inventor has provided portable multimedia devices for use in a personal services industry, for example the hair cutting industry, such as a hair cutting establishment. The devices generally comprise a microprocessor that is in data communication with a data storage drive, memory sufficient for booting and running an operating system for use on the multimedia device, a display screen, a speaker, and one or more ports that are A/V ports, communication ports, or networking ports, and a power source in electrical communication therewith. The multimedia devices further comprise a retaining member adapted for detachably mounting the multimedia device to a mounting member. The mounting member can be a hair cutting tool to which the multimedia device can be attached without interfering with the hair cutting tool's use while still allowing full use of the multimedia device while the tool is in use, independent of whether the device is mounted or detached. The mounting member can also comprise a clip-on device, a handle, a suction cup, a gooseneck mount, a flexible joint mount, a magnetic mount, a key ring or the like.

In another of its several aspects, methods of using the multimedia devices are provided herein. Thus, methods of interacting with a client in a personal service establishment, such as hair cutting establishment are disclosed. The methods comprise the steps of accessing at least one electronic media file on a portable multimedia device detachably mounted to a retaining member, and playing or displaying the electronic media file for the client. The electronic media file can be of any type or kind. The retaining member can be attached to a mounting member comprising a hair cutting tool, such as hair clippers, or a clip-on device, handle, suction cup, gooseneck mount, flexible joint mount, a magnetic mount, a key ring or the like.

In another aspect, the provided herein are universal mounting systems for a portable electronic devices. The mounting systems feature a retaining member for retaining the device; and a mounting member for mounting the device to an object or surface. The retaining member and the mounting member are preferably detachably connected. In various embodiments, the mounting member comprises a handle, a clip for clipping the device onto an article, a suction cup, a gooseneck mount, a flexible joint mount, a key ring, a magnetic mount or similar useful mounts. The retaining member and mounting member can be unitary in some embodiments. The digital/electronic device is retained in the retaining member via one or more screws, clips, or by friction, and the retaining member and the mounting member are attached to each other via inter-engageable members, snaps, or clips, or they are constructed as a unitary member.

In another of its several aspects, the invention provides methods for improving client relationships in a personal services business, such as a hair cutting establishment, comprising the steps of:

a) creating a database of client data for a plurality of clients, including for each client:
(i) at least one client identifier and at least one client preference for a personal service being provided,
(ii) and optionally, other client data including
   (A) preference data for one or more of music genres, celebrities, songs, videos, sports, sports teams, athletes, hobbies, cars, foods, books, movies, and/or pets, or
   (B) personal data including one or more of birthdate, anniversary, family members, nickname, Zodiac sign, occupation, employer, colleges, military service and the like;

b) creating a library of electronic media files comprising one or more of photographs, music, videos, documents (e.g. articles), and books;

c) associating at least one electronic media file with at least a first client; and

d) accessing the database to make the electronic media file available to the first client when the first client has next receives the personal services from the business;

wherein the database is stored in and the media file is displayed on a portable multimedia device detachably mounted to a retaining member for use by a person providing the personal service and/or the client.

In one embodiment, the invention methods provided are for improving client relationships in a hair cutting establishment, and comprise the steps of:

a) creating a database of client data for a plurality of clients, including for each client:
(i) at least one client identifier and at least one client preference for hair cut or hair style,
(ii) and optionally, other client data including
   (A) preference data for one or more of music genres, celebrities, videos, sports, sports teams, athletes, hobbies, cars, foods, books, movies, and/or pets, or
   (B) personal data including one or more of birthdate, anniversary, family members, nickname, Zodiac sign, occupation, employer, colleges, military service and the like;

b) creating a library of electronic media files comprising one or more of photographs, music, videos, documents (e.g. articles), and books;

c) associating at least one electronic media file with at least a first client; and

d) accessing the database to make the electronic media file available to the first client when the first client receives hair cutting or styling services from the hair cutting establishment;

wherein the database is stored in and the media file is displayed on a portable multimedia device detachably mounted to a hair cutting tool.

Also provided herein are kits comprising a portable multimedia device, a suitable mounting for detachably mounting the device to a mounting member included on, for example, hair clippers, clip-on apparatus, a key chain, a handle, a suction cup mount, gooseneck mount, flexible mount, or the like to which the device can be mounted. Optionally, the kits include instructions for use, and/or suggestions for improving relationships with clients in the personal services industry, for example, the hair cutting industry, particularly though use of the multimedia device.

These and/or further aspects, features, and advantages of the present invention will become apparent to those skilled in the art in view of this disclosure.

### BRIEF DESCRIPTION OF THE DRAWINGS

FIG. 1 shows an overview of one embodiment of the device described herein. A portable multimedia device is mounted to the back of a hair clipping device and provides a variety of client management and communication functions.

FIG. 2 shows side views/profiles of a representative embodiment of a the multimedia device. FIG. 2A, left-side view. FIG. 2B, right-side view.

FIG. 3 shows key data management paths for an embodiment of the computer product provided herein.

FIG. 4 shows a flow chart for power distribution for an embodiment of the multimedia computer system.

FIG. 5 shows representative logic for the data input module in an embodiment of the computer product disclosed herein.

FIG. 6 shows a representative data set for a hypothetical client after entry into the multimedia digital device

FIGS. 7-10 show embodiments of the mounting system described herein. The mounting system is useful for any portable electronic/digital device, including the devices disclosed herein.

FIG. 7: An embodiment of a two-part inter-engaging mounting system (e.g. for hair clippers as shown); Panel A: Example of a mounting member for mounting to a hair clipping tool with removable back plate depicting slots for receiving device retaining member; Panel C: Example of device retaining member having L-shaped finger members for inter-engagement with slots of mounting member; Panel C: Overview of hair clippers showing the backplate removed for mounting a multimedia device.

FIG. 8: Example of snap-in mounting system with handle mounting member; Panel A: Angled front view of retaining member featuring snap-in mounting system; Panel B: Cross section of device retaining member shown in Panel A; Panel C: Mounting member featuring dedicated handle for holding multimedia media device.

FIG. 9: Example of friction mounting system with mounting member featuring clip-on mount. Panel A: Angled front view of retaining member showing frictional retaining loops for retaining the multimedia device; Panel B: Side view of retaining member shown in Panel A; Panel C: Mounting member permitting attachment of retaining member with retaining clips and also featuring clip-on mount.

FIG. 10 depicts several embodiments of the mounting system provided herein. As shown, the mounting system is of the snap-in type however, clip-in mounting or inter-engageable members and other mountings system are compatible with each of the variations shown. Panel A: clip-on mount; Panel B: mounting to a hair clipper; Panel C: magnetic mount; Panel D: key ring mount.

FIG. 11: Panel A shows the multimedia device connected to a computer via, for example, a USB port for charging the battery, to enter client information, transfer data, upload media, back-up data or the like; Panel B depicts the multimedia device connected to a Bluetooth headset to allow, for example, a private phone call by a barber while the device is attached to a hair clipper which is in use on a client.

### DETAILED DESCRIPTION

Provided herein are portable computer products, generally portable multimedia devices for use in improving the client experience in the personal services industry, for example, the hair cutting industry, and methods for use of the product. The devices are preferably detachably mountable to mounting receiver, e.g. a handle or a tool used by the professional, such as a hair clipping tool for use by a barber or stylist to improve relationships and communication with a client and to generally increase the client's enjoyment of the time spent waiting for and/or receiving the service. The methods described for use of the multimedia device generally include the steps of entering client-related data, entering useful dates, entering media and other data, accessing data relevant to a particular client, and subsequently using the results to improve relationships and/or communications with a client.

Definitions & Abbreviations

Unless expressly defined otherwise, all technical and scientific terms, terms of art, and acronyms used herein have the meanings commonly understood by one of ordinary skill in the art in the field(s) of the invention, or in the field(s) where the term is used. In accordance with this description, the following abbreviations and definitions apply.

As used herein, the singular form of a word includes the plural, and vice versa, unless the context clearly dictates otherwise. Thus, the references “a”, “an”, and “the” are generally inclusive of the plurals of the respective terms. For example, reference to “a member” or “a method” includes a plurality of such “members” or “methods.”

The words “comprise”, “comprises”, and “comprising” are to be interpreted inclusively rather than exclusively. Likewise the terms “include”, “including” and “or” should all be construed to be inclusive, unless such a construction is clearly prohibited from the context. Further, forms of the terms “comprising” or “including” are intended to include embodiments encompassed by the phrases “consisting essentially of” and “consisting of”. Similarly, the phrase “consisting essentially of” is intended to include embodiments encompassed by the phrase “consisting of”.

Where used herein, ranges are provided in shorthand, so as to avoid having to list and describe each and every value within the range. Any appropriate value within the range can be selected, where appropriate, as the upper value, lower value, or the terminus of the range.

The methods and devices and/or other advances disclosed here are not limited to particular methodology, protocols, and/or structures described herein because, as the skilled artisan will appreciate, they may vary. Further, the terminology used herein is for the purpose of describing particular embodiments only, and is not intended to, and does not, limit the scope of that which is disclosed or claimed.

Although any devices, methods, articles of manufacture, or other means or materials similar or equivalent to those described herein can be used in the practice of the present invention, the preferred compositions, methods, articles of manufacture, or other means or materials are described herein.

All patents, patent applications, publications, technical and scholarly articles, and other references cited or referred to herein are in their entirety incorporated herein by reference to the extent permitted under applicable law. Any discussion of those references is intended merely to summarize the assertions made therein. No admission is made that any such patents, patent applications, publications or references are prior art, or that any portion thereof is either relevant or material to the patentability of what is claimed herein. Applicant specifically reserves the right to challenge the accuracy and pertinence of any assertion that such patents, patent applications, publications, and other references are prior art, or are relevant, and/or material.

As used herein the “personal services industry” includes any profession wherein a client or customer receives a service in-person from a business person, preferably a licensed practitioner or licensed professional, such as in the grooming, medical, and educational fields. Personal services businesses as used herein involve customer interactions with the professional or business, and in many cases direct in-person contact. In some embodiments, the service is a direct, hands-on service. Examples of such services include those rendered by professionals in the medical industry including doctors, dentists, chiropractors, nurse practitioners, alternative health practitioners, and the like, cosmetologists of all types, including hair cutting professionals (e.g. barbers and hair stylists), colorists, shampoo technicians, manicurists, estheticians and other skin care professionals, nail technicians, and electrologists, as well as pedicurists, nail artists and technicians, make-up and eye-brow technicians, and body workers of many types including masseuses, tattoo artists, and the like. Other services include animal/pet groomers, tour guides, shoe shiners, personal shoppers, valets, chauffeurs, even and attendants. Also included for purposes herein are other helping professions, such as teachers, coaches, personal trainers, and even managers such as sales managers, and others. Presently preferred are services in the hair-cutting industry, particularly those provided by barbers, stylists, technicians, groomers and the like. Other preferred services are those provided by teachers, coaches, medical practitioners, and the like.

The term “client” as used herein includes any customer, patient, student, coaching client, business contact, employee or person being managed, or the like who uses the services of a personal service provider, or similar professional and for whom the professional providing the service(s) wants to improve the service experience for the client, and or store and access data related to the client for the purposes of providing services better tailored to that client's needs or wants. As discussed below, in some cases a client may be a animal, such as a companion animal who is receiving services paid for by a human caregiver.

As used herein the terms “professional”, “professional service person”, “professional service provider”, “practitioner”, and “service provider” are generally synonymous. Specific to the hair cutting industry, “professional hairstylist”, “hairstylist”, “stylist”, “barber”, and the like are equivalent and intended to convey any person who cuts, styles, or grooms hair for another, or provides personal services in the hair cutting industry. The term includes those who groom the hair or coat of animals, such as companion animals, particularly dogs and cats. In the case of animal grooming, the skilled artisan will appreciate that the devices and methods provided herein may pertain to and or relate to information about both the grooming subject/client (e.g. the companion animal) and the paying person/client (e.g. the human who brings the animal for such grooming and pays for the services). Moreover, for such embodiments, the term “client” with respect to data, preferences, and the like refers to such data and preferences for either the human client or the animal client. For example, the business person may learn that the animal client has sensitive ears, and that the human client likes large breed dogs, and classic rock music.

As used herein, “barbershop”, “salon”, “shop” or “retail haircuttery” are sometimes used interchangeably and refer generally to any retail location, including mobile locations that are driven or brought to a client, where a client's hair is attended to by a barber, hairstylist, groomer, or the like. They also include any location where a professional rents a workstation, chair, room, counter space, or the like to provide services to a client desiring such services from the professional.

As used herein, the phrases “computer product”, “computer device”, “multimedia device”, “digital device” are generally synonymous, unless otherwise clear from the context. Moreover, although the devices are sometimes described with reference to applications of the product to the hair cutting or hair styling industry, the device is not limited to any particular industry or type of personal service, and the skilled artisan will understand that the device and any such applications may be readily adopted by professionals in the other industries or practices, not limited to those described above.

The term “athlete” as used herein refers to anyone who plays or participates in any sport or related activity, whether individually or as part of team, professional or collegiate, or other. Thus, “athlete” includes players of any team sport (e.g. football, baseball, basketball, hockey, lacrosse, softball), as well as individual participants in sports or related activities such as boxers, martial artists, race drivers, Olympians or the like.

The term “celebrity” as used herein includes anyone of any public notoriety. The term as used herein includes movie and/or television actors, personalities, or stars, newsmakers, professional athletes, recording artists, singers, musicians, entertainers, performers, other artists, and the like.

As used herein the term “gooseneck mount” refers to a mount comprising a flexible shaft of a type commonly seen on certain lamps, such as desk lamps, which can flex into various curved or sigmoidal shapes and resembles the neck of a goose in the sigmoidal form. The gooseneck mount allows an object therewith to be positioned at various angles or directions convenient to the user.

As used herein “flexible joint mount” refers to a flexible mounting comprising multiple joints wherein the flexible joint mount can conveniently and quickly be attached to a variety of objects with different shapes (including irregular shapes) and/or surface textures by bending one or more flexible joint legs comprising multiple joints into various configurations on or around the object to secure the mount to the object. The flexible joint mount can be mounted and/or unmounted numerous times to a wide variety of different objects to which mounting might otherwise be difficult. Flexible joint mounts are known in the art, for example in tripods comprising three flexible joint legs for mounting cameras.

Abbreviations

The following abbreviations apply unless indicated otherwise:

CD: compact disc;

CD-ROM: compact disc read-only memory;

CPU: central processing unit;

DOB: date of birth;

dpi: dots per inch;

Gb: gigabyte;

GPS: geopositioning system;

GTD: Getting Things Done;

HD: high-definition;

Kb: kilobyte;

LCD: liquid crystal display;

LED: light emitting diode;

Mb: megabyte;

MP3: MP3 (music) file;

MMS: multimedia messaging service;

MP4: MP4 media file, e.g. video;

PDA: personal digital assistant;

RAM: random access memory;

RFID: radio frequency identification;

ROM: read-only memory;

SIM: subscriber identity module;

SMS: short messaging service

USB: universal serial bus;

WAN: wide-area network;

WAP: wireless access protocol; and

Wi Fi: Wireless Fidelity; IEEE 802.11b standard for wireless networking

### Detailed Description of Illustrative Embodiments

In a first of several aspect, provided herein are computer products, e.g. portable digital devices for use by professional service providers in the personal services industry, for example, in the hair-cutting/styling industry, particularly barbers, stylists, technicians and groomers. The product is a device that is suitable for use in a variety of industries where a professional renders in-person services to a client. The in-person services are preferably one-on-one services. In some embodiments these services are hands-on services, i.e. services that involve a professional physically touching a client. The client is generally a human, but can also be a companion animal, for example a dog or cat. The professional or service provider may be a licensed professional, such as a doctor, nurse, teacher, barber, stylist or any profession that deals directly with clients or the like.

The computer product is generally a portable multimedia device that is preferably detachably mountable to a mounting receiver or handle, or to a tool used by the professional/services provider. In a presently preferred embodiment, as applied in the hair cutting industry, the portable multimedia device is detachably mounted to a hair cutting tool, for example a hair clipper, without interfering with the primary and/or intended use of tool. For example, the computer product does not interfere with the use of the hair clippers, i.e. with the cutting and styling of hair. The multimedia device is useful for improving the client relationship management for the barber, improving communications with clients, and improving the enjoyment of the services by the client. The device, including the screen, is preferably dust-resistant, hair-resistant, water-resistant, chemical-resistant, scratch-resistant, shock-resistant ‘unbreakable’ using known technology, for example, valox resin and aluminosilicate glass. Also provided herein are methods of using the multimedia device as described below.

One feature of the computer product/device is the generally detachable mounting described herein. The mounting handle or mounting receiver may be a dedicated handle in some embodiments, which handle serves solely to hold the device in detachable fashion for use by the professional and/or the client. In other embodiments, the mounting receiver may involve a tool used by the professional, and/or the client.

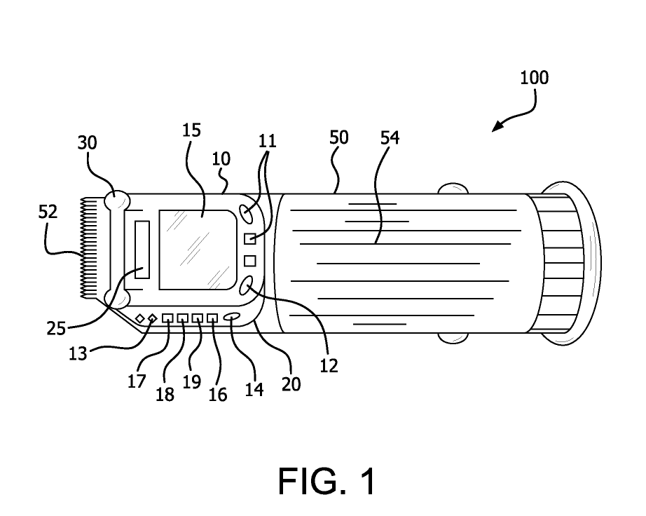

One example of such a tool for the hair cutting industry is a hair cutting tool such as a hair clipper, as shown in FIG. 1, which can physically receive and hold the computer device as described in more detail below. Alternatively the multimedia device can be mounted to a mounting receiver, described in more detail below. In various examples applicable to any modern digital device, the mounting receiver comprises a dedicated handle, a clip-on holder, a key ring, suction cup, magnetic attachment, gooseneck mount, a flexible joint mount, or the like. These are described in further detail in connection with the mounting system provided herein.

Several aspects of the invention can be further understood through reference to the drawings. FIG. 1 shows an embodiment of the computer system (100) sometimes referred to as a portable multimedia digital device. As can be seen, the system (100) generally features a portable computer device (10) that is preferably detachably mounted via a mounting receiver (20) to a hair cutting tool such as a hair clipper (50). The hair cutting tool comprise at least a cutting section (52) and a body (54). The computer device (10) is similar in some respects to a small PDA or similar digital tools or devices, but is not merely a laptop computer. The device (10) comprises a video display (15) that is preferably full color and capable of displaying video at high-resolution and at fast speeds. The video display (15) is described in more detail below.

Typical dimensions for the device (including the display screen) are less than 3″ square in some embodiments, and less than about 2.5″ square in other embodiments. Still other embodiments feature dimensions of less than about 2″ or about 50 mm square. The thickness of the device is preferably less than about 1″, and more preferably less than about 0.75″ or even 0.5″.

The computer device (10) also comprises a number of accessible control buttons, such as power button (12), volume control (14), video controls (16, 17, 18, 19) and other controls (11, 13). The control buttons may be provided via hardware (e.g. physical buttons) or software (e.g. software settings or control metaphors). The device (10) also preferably includes an external speaker (25), and a LED light (30) having one or more LEDs.

The device further comprises a power supply/source (preferably a rechargeable battery such as a lithium ion battery, a NiCAD battery, or the like), one or more processors, including a CPU and optionally additional processors (not shown) to handle one or more of data input or output, video rendering/display, sound output, multi-tasking, and/or other functions. Also featured are memory (not shown), including ROM and RAM-type memory or other memory sufficient to allow the device to boot or start up as well as to run an operating system, various modules described herein, and such optional software applications (“apps”) as may be desired.

The device also comprises a data storage unit (not shown) having capacity to store data of any type for a prolonged time until access is required. The data storage is preferably capable of being written to and/or read from multiple times, such as a hard-disk, flash drive, memory card, or similar data storage device. The device may also comprise a slot (44) for an additional card such as a memory card. The additional card may provide additional memory or allow transfer of data.

Other aspects of of the computer product will be evident to the skilled artisan, such as inputs and outputs sufficient to allow for a display, speakers, connection to one or more other computers or devices having processors and the ability to network. Presently preferred are embodiments comprising the ability to connect to and/or host one or more of a USB connection (40), Firewire connection (42), Ethernet connection (43), RS 232-type connection, or other connection capable of high-speed data transfer and/or power transfer to one or more connected devices or peripherals, including mass storage devices, human interface devices, or others. Also preferred at present are devices which support and can use wireless communications, such as a WAP wireless protocol.

The device may optionally comprise a camera (allowing still photography, video (including HD), or both), audio input (e.g. voice recording), radio (e.g. AM/FM/Emergency bands), a GPS receiver, or a satellite receiver (e.g. for satellite radio). Where a camera and a light are both included, the device may allow the light to serve a flash function to assist lighting for the camera. Moreover the device may feature a front-facing camera, rear-facing camera, or both.

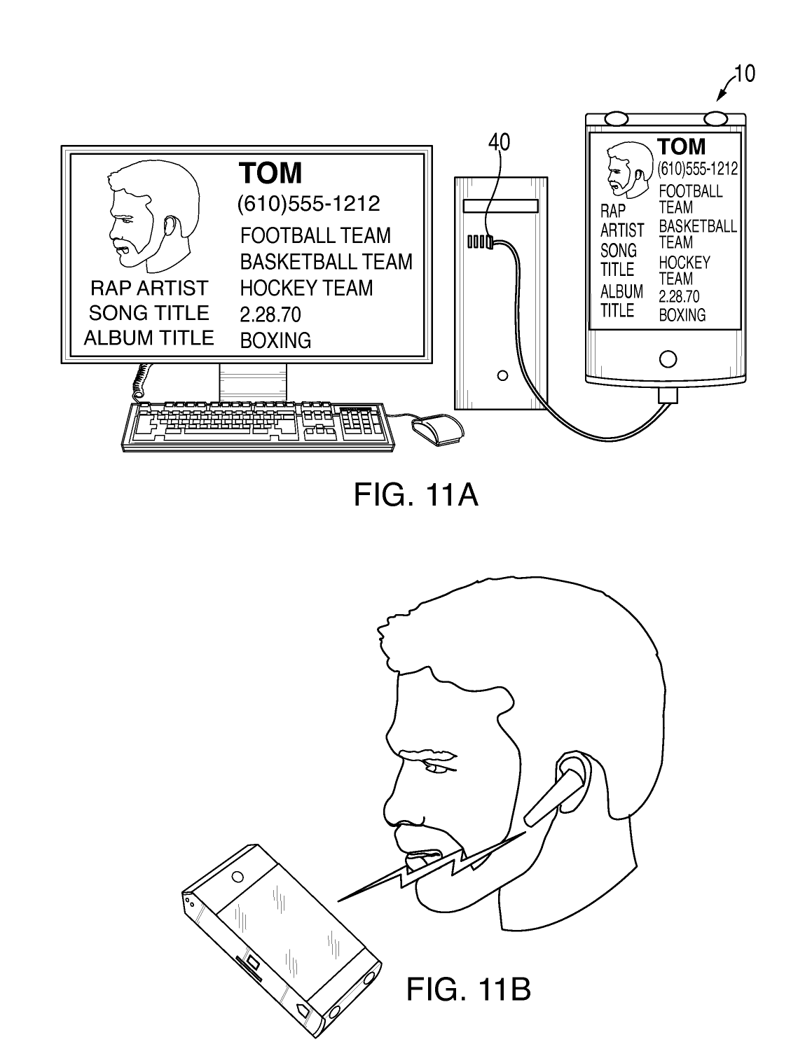

The device can also optionally accommodate telephone protocols, SMS or MMS protocols, and a SIM card or other means of identifying the phone aspect to a network. Such options allow use of the device for both telephone and texting. Communication with other devices, computers (including personal computers) and/or public or private networks can be facilitated via Bluetooth communications, USB ports (for example USB 1.x, 2.x, 3.x or higher), other wireless communications such as one or more WAP layers, Wi-Fi connections, and the like. (See FIG. 11). Such networking functions allow the devices to communicate with the internet, as well as other devices including computers, smart phones, or related devices to exchange data or other information. In one embodiment, the devices can be used to send text or multimedia messages to an individual client, for example appointment reminders or a photograph or video clip of interest. In other embodiments, the devices can be used to send group messages, for example a promotional message containing advertising, marketing or sales information, or a message containing educational information of interest to a group of clients, or simply news or announcements of interest to clients.

In yet other embodiments, the multimedia devices can communicate with each other, to allow, for example, data sharing, messaging, competitive or noncompetitive game playing, or other social interactions. In one embodiment clients can compete with each other in a competitive game, quiz, or the like. For example, checkers may be a popular game in certain barbershops and clients receiving service may enjoy playing such games. Alternatively, a barbershop could use such a feature to otherwise entertain clients.

The devices can optionally be useful tools within the professional's business by for example allowing easy storage, access or manipulation of financial information and other information important to the business, such as accounting and tax information, bill payment, inventory management for key supplies, and the like. In one embodiment, the device can include credit card processing through software applications, or through simple attachments (not shown) such as similar devices that are currently known and used with smart phones. Such devices can, for example, allow convenient communication with credit card processing companies and can allow transfer of funds to a credit card merchant account or the like. Preferably, this functionality will permit the device to read the magnetic strip on a client's credit card.

In another embodiment, the multimedia digital device can further comprise a bar code reader (not shown) or RFID reader (not shown) that allows the service provider to read a card or ID issued to the client. For example, barbers can issue cards or IDs to a client having a bar code or RFID. The cards can also ‘double’ as business cards and can be conveniently placed on key rings or in wallets. On the clients' subsequent visits to the barber, the barber can quickly/easily scan the bar code or RFID to retrieve the client's data including service history and preferences. The bar codes and/or RFIDs can allow rewards or discounts based for example on patronage frequency, birthdays, anniversaries, or the like.

The portable multimedia device (10) preferably has a color display (15) with sufficient resolution to display video clips, high-resolution photographs, e-books etc in a readable or viewable form. The display may be of any type known in the art, e.g. a LCD or LED display, or other display screen that is sufficiently small and reasonably lightweight. In preferred embodiments, the screen can include touchscreen technology wherein the screen is responsive to touch to allow, for example, navigation through user selectable menus, and/or selection and use of graphical icons to control operations.

The device (10) also preferably has one or more external speakers (25) on-board. The speakers are preferably of sufficient quality to allow voice and music playback. The portable multimedia device (10) also may have the ability to receive a set of headphones (not shown) and to alternatively play audio through either of the speakers (25) or the headphones if attached. Advances in recent years in speaker technology have permitted substantial reductions in the size required to attain great fidelity and volume in very small speakers. Such technology and the resultant small high-quality speakers are useful in connection with the multimedia device disclosed herein.

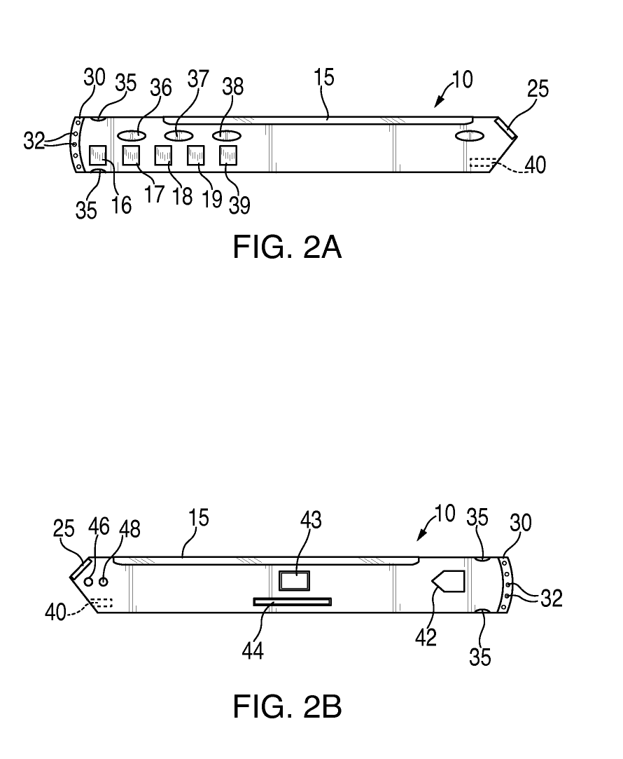

With further reference to the figures, FIGS. 2A and 2b show an embodiment of the computer product/multimedia device (10) from the opposing side views. As can be seen in FIG. 2A the device (10) comprises an LED light (30) that is front facing relative to the hair clipper (50). The LED light (30) can comprise one or more LED ‘bulbs’ (32) including LED light that is of visible wavelengths and/or of ultraviolet wavelengths. The utility of such a light (30) will be apparent to one of skill in the art. For example, visible light will provide local light on the work area to facilitate a better result. It will also allow the barber to detect certain disease conditions infestations, or scalp problems. This allows the professional to advise his client of such conditions so that self-help or medical treatment can be sought if needed. The light can also serve as a flashlight in the event of a power failure or other emergency.

As can also be seen the computer device (10) comprises a number of buttons or controls to allow the barber to conveniently control many of the functions of the device without having to access the operating system for desktop. For example, the device has an on/off or power button (12). There are also controls for volume (14) e.g. of the external speaker (25), for control of the video display (15) such as brightness or contrast, and for controlling video playback such as fast-forward (16), rewind (17), and play/pause (18/19). The skilled artisan will appreciate that many of these can be combined with other functions, e.g., by requiring multiple presses to access different functions associated with a single button. The skilled artisan will also appreciate that in embodiments where the multimedia device features a touch screen, physical control buttons for many functions may be included, but are purely optional. In some embodiments, the touchscreen device provides all controls via on-screen functions.

If the device includes an optional camera (35), then controls for operating the camera (35) may also be included for example the on/off button (36) for the camera (35) and on/off button (37) for the optional flash, and zoom in/out (38) on the optional zoom. Similarly, if the device includes an optional voice recorder a controller can be present to allow one touch recording of voice messages or voice memos (39).

The computer device (10) also preferably features an external speaker (25) which is suitable for playback of music, or audio track associated with the video. Clients will enjoy a high-quality of audio playback, and as discussed above, the speaker (25) should be of sufficient quality to ensure the sound is enjoyable and not annoying for the client, e.g. by having low poor quality sound or insufficient volume for the circumstances. Speakers providing HD-quality sound are available and known to the skilled artisan. The sound on the device may also be alternatively played wirelessly through other speakers in some embodiments.

The video display screen (15) is preferably full-color, and also preferably includes one or more antiglare features to allow the client to view video in a lighted shop. Presently preferred display screens are optionally touch sensitive and allow convenient navigation or operation of the device.

As can be seen from FIG. 2B the device can also feature USB (40), Bluetooth (42), or other networking or communication connections. The device may also feature jacks (46, 48) for receiving headphones for listening to audio or microphones for inputting voice or other sound. Yet other optional components of the multimedia device include the credit card module and the bar code/RFID readers described above.

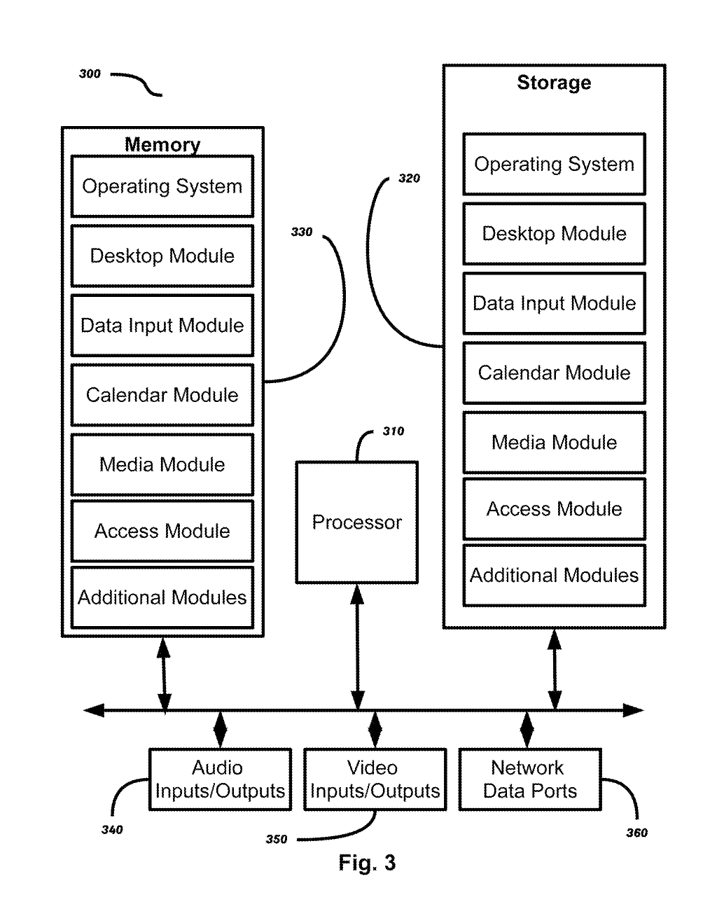

With further reference to the figures, FIG. 3 shows representative data management system (300) for an embodiment of the multimedia device (10). As can be seen, the long-term storage (320), such as a disk drive or other readable/writable storage contains the Operating System (321), the Desktop Module (322), the Data Input Module (323), Calendar Module (324), Media Module (325), Access Module (326), and additional Modules (collectively, 327), such as additional software, for example downloadable “apps”installable by the user. The memory (330) of the multimedia device (10), which can include both RAM and ROM memory, can transiently store for rapid retrieval information and code required for running the Operating System (321), the Desktop Module (322), the Data Input Module (323), Calendar Module (324), Media Module (325), Access Module (326), and such Additional Modules (327) as are included with the system or installed by the user. Of course the processor (310) is central to the data management. While the processor (310) shown appears to be a single microprocessor, there may in fact be multiple processors as part of one CPU, and/or by including specialized processors such as A/V processors, graphics processors, speech to text processors, text-to-speech, or other processors may be included. The system also includes a variety of audio (340) and video (350) inputs and outputs., as well as one or more network, data, or communication ports (360).

In normal operation, the user would power on the device and the operating system (321) would be booted up, in some cases after any useful self-diagnostic software checks. The Desktop Module (322) would preferably be the default program to run. The Desktop Module (322) generally serves to control the system/device and to provide a convenient interface to allow the user to select other modules to run. Suitable operating systems are known in the art for such devices, and a vast amount of software is available for such operating systems including commercial products, open-source projects, freeware, and shareware.

The Desktop Module (322) need not provide a ‘desktop’ metaphor, but can be any software, graphical interface-based, menu-driven, command-line driven, or other, that provides a ‘home screen’ which allows navigation of directories, files, and the like, and/or from which other programs or modules can be selected and/or launched. Presently preferred are the convenience, ease of use, and rapid learning curve associated with graphical interfaces and the multimedia device preferably comprises a graphical interface in connection with the Desktop Module (322) and/or other modules. Graphical interfaces are particularly preferred in conjunction with devices which feature touchscreen capability.

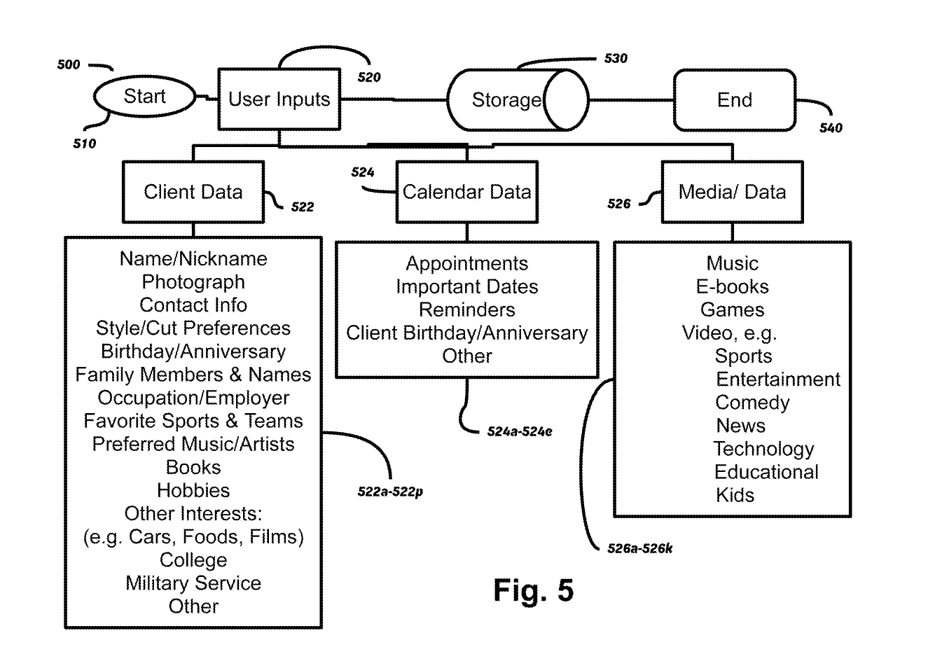

From the Desktop Module (322), the user can generally select any of the other functions. It should be noted that the Modules listed which are merely representative of those that may be included. The device may come standard with the listed Modules as well as many others. The Data Input Module (323) is described in more detail in connection with FIG. 5. The Calendar Module (324) is self-explanatory and provides at least the basic functions known in the art for calendar programs generally. For example, the Calendar Module (324) can display the current date, day of the week, etc. The Calendar Module (324) can further store and display appointments, events, tasks and other items associated with the current day, week, month, year, etc, or with any particular date in history or in the the future, e.g. to the extent data are available to the Module (324). The Calendar Module (324) can also provide reminders, and allow for automatic and/or prescheduled messaging. The Calendar Module (324) can conveniently provide prompts for upcoming appointment wherein the prompts include one or more client preferences to allow the profession to greet the client in a more personalized fashion.

The Media Module (325) can also be accessed from the Desktop Module (322) and is generally responsible for the management of a media library which is described below. The Media Module (325) can help store, organize, and display various forms of data including many different types of media files and data associated therewith. The media library managed by the Media Module (325) can be accessed by other Modules as needed, for example the Access Module (326).

The Access Module (326) can provide several important functions. For example, the Access Module (326) can provide search capabilities/services to the other modules such that data used by any module may be searched and/or cross-referenced by any other module. In practice, the Access Module (326) can allow the user to find media to display and/or play for a client based on the data input record for a given client. Based on a given client's preference data and the data in the media library, the Access Module (326) can cross-reference the media files of greatest interest to the client (based on preferences such as music genre/type, favorite artists, or even a playlist of favorite songs), and/or provide reminders or suggestions to the professional as to what media will most likely be enjoyed by or of interest to when services are being rendered to that client, or when that client is present in the shop. The Access Module (326) can also give that client access to the media of greatest interest where the client has been given the device to browse or use during his visit/appointment.

Other Modules (327) are optionally provided, for example a camera and/or photography module where the multimedia device includes a camera. A telephone and/or messaging module, including for example dial pad, phonebook, ringtones, and keypad functions is useful where the device includes telephone functions and/or circuitry. The phone module is preferably a full-functioned phone system with caller ID, voice mail, call waiting, call forwarding, conference calling, call history, and/or call blocking. A clock module is useful generally with the device for keeping and displaying time and maintaining the calendar, as well as providing alarm functions, stop watch or timer functions. Preferably the device is capable of automatically synchronizing periodically with an official networked time server to obtain and adjust the correct local time. A hands-free module is also useful wherein the user wears a head set, such as a Bluetooth headset, and the multimedia device can respond to voice commands, make and/or connect phone calls over the Bluetooth connection, and the like. (See e.g. FIG. 11, Panel B). In one embodiment, the personal service business's incoming phone number incoming phone number can ring through to the device and be answered via the headset, such that the professional need not stop providing the service nor walk away from the customer to answer an incoming phone call when needed.

In one embodiment, the multimedia device is WAP-enabled or has other connection to the internet, and the device includes a browser module or web browser application that allows the operator to ‘surf’ the World-Wide Web. In such embodiments, the user of the device can obtain updates from the internet including of course, news, weather, sports, financial/stock market information, and humor, other data or information.

In another embodiment, a task, to-do, or GTD module is provided to help the professional service person, such as a barber or stylist manage the tasks associated with the professional service business, including scheduling, ordering supplies, performing maintenance, cleaning or disinfection equipment, and other routine tasks or tasks specific to the personal services being rendered to clients, for example hair cutting.

The multimedia device in certain embodiments further comprises modules for speech to text and/or text-to-speech. The text-to-speech module is useful for allowing the device to ‘read’ text or documents such as SMS messages, email messages, or documents, and/or e-books which can provide a convenient way for the barber or stylist to access information without having to stop to read it. The utility of a speech-to-text module is discussed in further detail below. One application is for ease of data entry. Such a module can also be useful for dictating notes, tasks, and even messages to be sent, including emails and SMS messages.

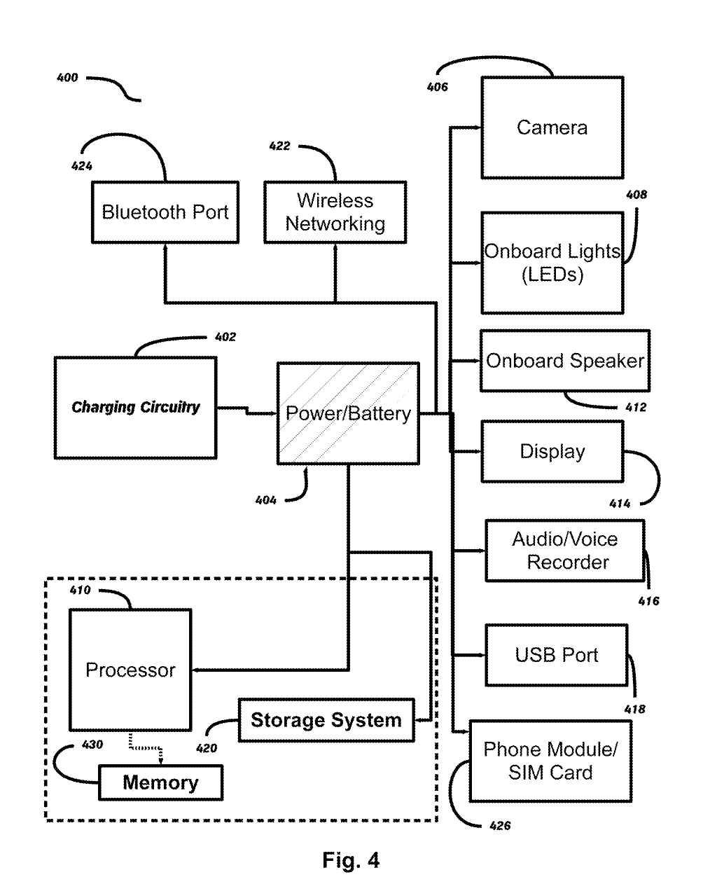

With yet further reference to the figures, FIG. 4 shows a representative power management system (400) for the multimedia device (10). The power management system (400) is based on the power supply and/or battery (404). Preferably the device features a battery (404) that is a lightweight, rechargeable battery with a long-life, for example, a NiCad battery or more preferably a lithium ion battery. The battery (404) is recharged or power is received from the charging circuitry (402). The multimedia device (10) can be charged in any of several ways, e.g. directly from a power converter plugged into a power receptacle, or for example through its USB port when plugged into a personal computer or other USB device capable of powering the unit, or it may even be charged. (See e.g. FIG. 11, Panel A).

Among the components of the multimedia device (10) requiring power are the processor (410), the storage system (420), and the memory (430) shown in FIG. 4. Power for these can be provided directly or indirectly from the battery (404).

With further reference to FIG. 5, various other components of the system also require power, for example, the camera (406), the onboard lights (408), the onboard speaker (412), the display (414), the audio /voice recorder (416), USB ports (418), phone module or SIM card (426), Bluetooth port (424), and wireless networking (422). Radio. GPS, or satellite receivers, if present, may also require power which can be provided via the power source/battery.

With further reference to the figures, the computer device, i.e. the portable multimedia device (10) provides an interface and a data input module (500) that permits certain useful data to be input into the device for later use/retrieval. As seen in FIG. 5, a user can input a variety of data using the data input module (500). In the embodiment shown, the user starts (510) and enters an input screen (520). The user is provided with options for entering for example Client Data (522), Calendar Data (524), or Media Data (526). If the user decides to enter Client Data (522), he can enter any data pertaining to a particular client and the client relationship. Examples of such data are shown in the figure and include general data such as name/nickname (522a), photograph (522b), contact info (522c) (for example phone numbers, e-mail address, physical address, and/or other contact information), client birthday or anniversary dates (522e), the client's family members, relationships and their names (522f), the occupation and employer of the client (522g), the client's favorite sports and teams (522h), preferred music (522i) (e.g. genre, type, artists, songs), favorite books (522j), hobbies (522k) and other interests (522l), for example, cars, foods, films. Other data such as a client's college (522m) or military service (522n) or length of time as a client or customer can also be entered in the Data Input Module (500). Data specific to the personal services being delivered can also be input. For example, for the hair cutting industry, hairstyle or haircut preferences (522d) and notes related to client likes and dislikes regarding their hair can be entered.

The skilled artisan will appreciate that other types of data particular to other services can be entered as may be useful. For example, a teacher could include test scores, grades, areas of strength as well areas to focus on for improvement, such as specific skills or drills, as well as information regarding the student's home life (e.g. for minor students, information related to parents, etc.). An athletic coach might include data related to recent performance numbers, e.g. time trials, weights lifted, etc., or statistics for particular sports or game-related activities. A life coach or the like might include various client goals or issues her client wants to work through, for example. A medical professional would likely value including medical data or information related to or helpful in improving the doctor's relationship with his patients, or making the healthcare system feel more personal and human. A sales manager might include data related to sales performance for his sales people as well as targets and goals, strengths, weaknesses and the like.

As to data entry, there are a number of ways of accessing the data input module. For example, the multimedia device may include a touchscreen which will allow direct entry of data, or the device may also include an optional voice to text module which allows voice entry of client data and other data. Preferably, most frequently client data will be entered by connecting the multimedia device to a personal computer. There may also be provided a module that readily allows import of existing client data from other software programs or applications such as contact managers that may be present on a personal computer.

While using the Data Input Module, the professional (e.g. barber, stylist or other) may also choose to enter calendar data. Such data will allow the multimedia device to help in the management of schedules for those clients that prefer advanced scheduling, or for those shops that require advanced scheduling rather than dropping appointments. Calendar data may thus include appointments, important dates, reminders, as well as client birthday or client anniversary data. Vacation schedules, holidays, closings, etc may also be entered. It should be noted that in addition to other functions the calendar data may allow a professional service provider (e.g., a barber or stylist) to send periodic e-mails or text messages to clients to remind them of appointments or office closures, or in recognition of a birthday anniversary retirement or the like. By automating such tasks, not only will client communications be improved, but the likelihood of actually having those communications sent in a timely fashion is greatly increased.

In the Data Input Module, the barber may also enter media-related data into the multimedia device to create a media library. Such media can include music (526a), e-books (526b), games (526c), and video (526d) such as sports (526e), entertainment (526f), comedy (526g), news (526h), technology (526i), educational video (526j), or kids videos (526k). Data associated with the media may also be entered into the system (500). For example, data associated with music media can include album name, artist name, song name, year of recording, composer, etc. As discussed above, the system, for example the Access Module, allows cross-referencing of client data and the media library such that a client with interests that relate to a particular type of media in the library can be presented with such media during their visit to the shop. For example, if a client is interested in sports, and in particular professional football, once the service provider (e.g. barber) knows that clients favorite football teams media related to that football team such as video clips and sound clips can be presented during a client visit, i.e. while the client is getting their hair cut. If a client is interested in music, for example, classic rock, easy listening, jazz, hip-hop, classical or country-western, then that client may be interested in hearing the latest hits, or a personal playlist of his favorite music, or watching videos related to that particular type of music while getting a haircut.

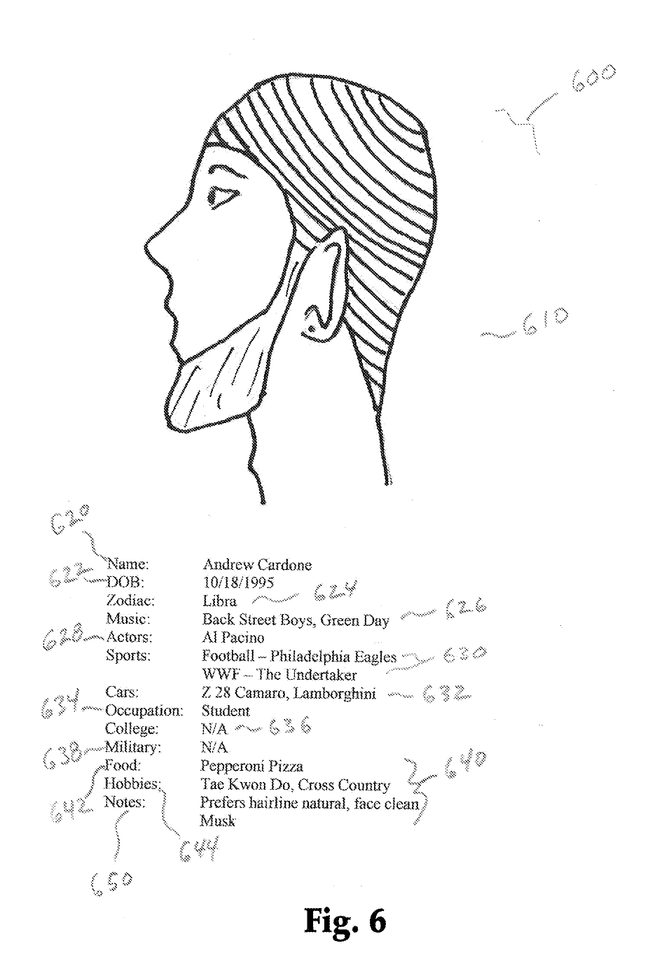

As can be seen from FIG. 6, a representative client data entry (600) is shown for a hair cutting client. The data may include a photograph (610) of the client, as well as a name or nickname (620). Also included are the birthdate (i.e. D.O.B.) (622), which can facilitate sending birthday wishes, birthday discount coupons, or the like. The data entry fields also include the client's Zodiac sign (624), and likes as to celebrities (e.g. musical artists (626), actors (628)), sports (630), and cars (632). The client's occupation (634), college (636), and military service (638) data are also included. Additional information (640) of any type may be included, and is shown in the figure in the form of food preferences (642), and hobbies (644). Also present are notes (650) indicating the client's hair cut and style preferences and after-shave/cologne choice.

It will occur to the skilled artisan that the entry of such data presupposes that the service provider (e.g. barber) has the information and/or data to enter. The client information and/or data can be acquired over time as the client frequents the shop and the client relationship grows organically. To expedite the process, the service provider can ask the key questions during the first visit, or for example in a questionnaire. In one embodiment, the client is given the questionnaire and is incentivized to complete the responses to the questions for example by giving a coupon or discount on a future visit or similar incentive, such as a free service during a future visit. Such incentives will increase the likely the speed at which the service provider can build up his database and begin the maximize the return on investment in the multimedia device.

In another aspect of the invention, a mounting system for electronic devices is provided. The mounting system is useful with the multimedia device described above, but as the skilled artisan will appreciate, is also useful with any portable electronic device, including cellular phones, GPS devices, tablet computers, MP3 players, and the like. The mounting system and its use will be described first with reference to the multimedia digital device provided above, as one presently preferred feature of the multimedia computer product disclosed above is the ability for the portable device to be mounted via a mounting component to a tool, or other mounting receiver, e.g. a hair clipper where it is readily accessible to the barber. Thereafter, the mounting system will be described more generally, as it may be used with any portable electronic device.

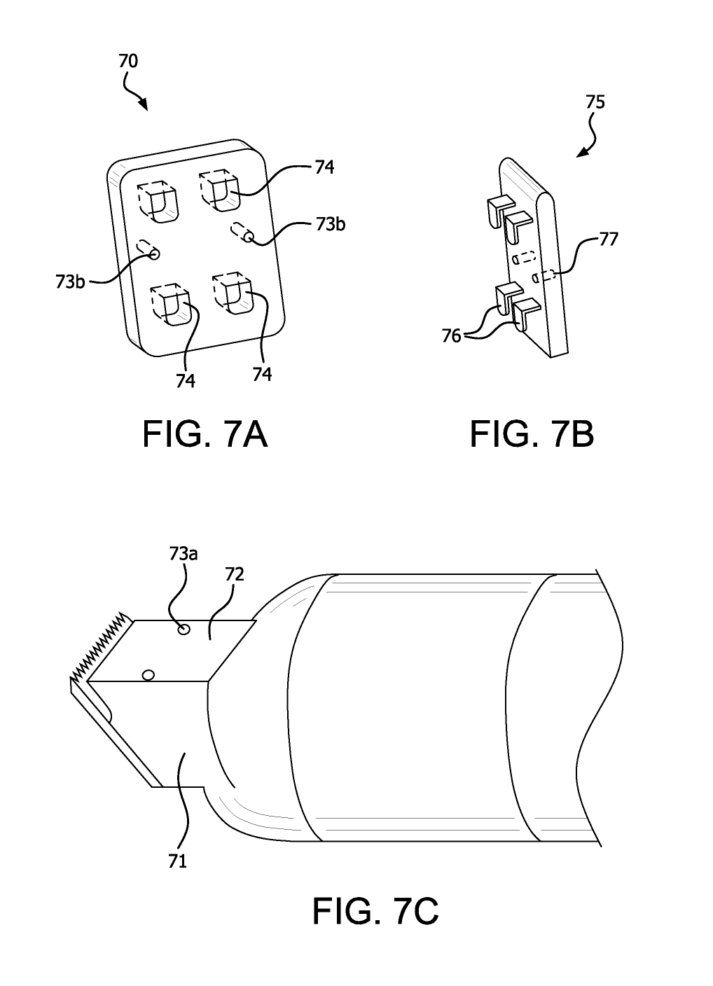

With further reference to the figures, FIGS. 7-10 show various embodiments of the mounting system disclosed herein. The detachable mountings or mounting component of the multimedia device can comprise screws, clips, hooks and loops, or other inter-engageable members, such as complementary male and female members. The multimedia device can also be detachably retained with various forms of friction mounts that will allow the device to be mounted and firmly held, but easily removed by, e.g. applying a force exceeding a certain minimum ‘yield force’ which will surpass the friction forces holding the device in place. Such friction mounts can include portions that supply spring force to help retain the device. The skilled artisan will be familiar with the use of related mounts such as are known in the art.

In yet other embodiments, the device can be mounted via complementary-shaped male and female engaging members such that the device can, for example be slidingly engaged in a first direction so as to prevent the device from falling out accidentally and yet allow easy removal by sliding the device out in a second or reverse direction.

In a preferred embodiment, the mounting component is adapted for detachably mounting the multimedia device to a mounting receiver. It should be clear that in various embodiments, the computer device can be designed to mount to a tool used by the professional, for example, to hair clippers, and also to be similarly mounted to a family of related mounting receivers that include handles, clips, suction cups, gooseneck mounts, flexible joint mounts, and other mountings that can similarly hold the computer device and preferably attach it to another object or to a surface where it may be conveniently used. The types of mounting receivers, e.g. tools or handles, etc. to which the device is mounted may vary from industry to industry and professional to professional. For example, a doctor may prefer the device mounted to a clipboard with, e.g. VELCRO-type closure material or a magnetic mount. A teacher may prefer the device be clip-mountable to a book or study guide that varies from class to class or student to student. A sales manager may need the device safely mounted for access during travel, and may require a gooseneck mount to allow adjusting the height and viewing angle.

In one presently preferred embodiment, a barber may have the device mounted on his hair clippers, which may be adapted to receive the multimedia device or the mounting component thereof. The barber may later wish, for example, to pass the device to his client to allow the client to view and/or listen to a media file. Preferably, without the use of any tools, the service provider can quickly and easily by hand remove the computer device from the mounting on the hair clippers and mount the computer device into a handle, clip-on mount, suction cup, gooseneck mount, flexible joint mount, magnetic mount, or other mount adapted to receive the device, such as a key ring, and allow the client to handle, view, and/or listen to the device therefrom.

In various embodiments dedicated for the hair cutting industry, the mounting component/members comprise attachments that allow the device to be mounted to the back side of the hair clippers, i.e. the side that faces the barber or stylist while the clippers are in use. Preferably, the detachable mounting is adapted to permit the device to be located (i.e. mounted) on the clippers or removed quickly and without the use of tools so the the device can be handed to the client, preferably after placing the multimedia device in another mounting member comprising a handle, key ring, clip-on mount, suction cup, gooseneck mount, flexible joint mount or the like. The surprising advantages of this arrangement will become evident.

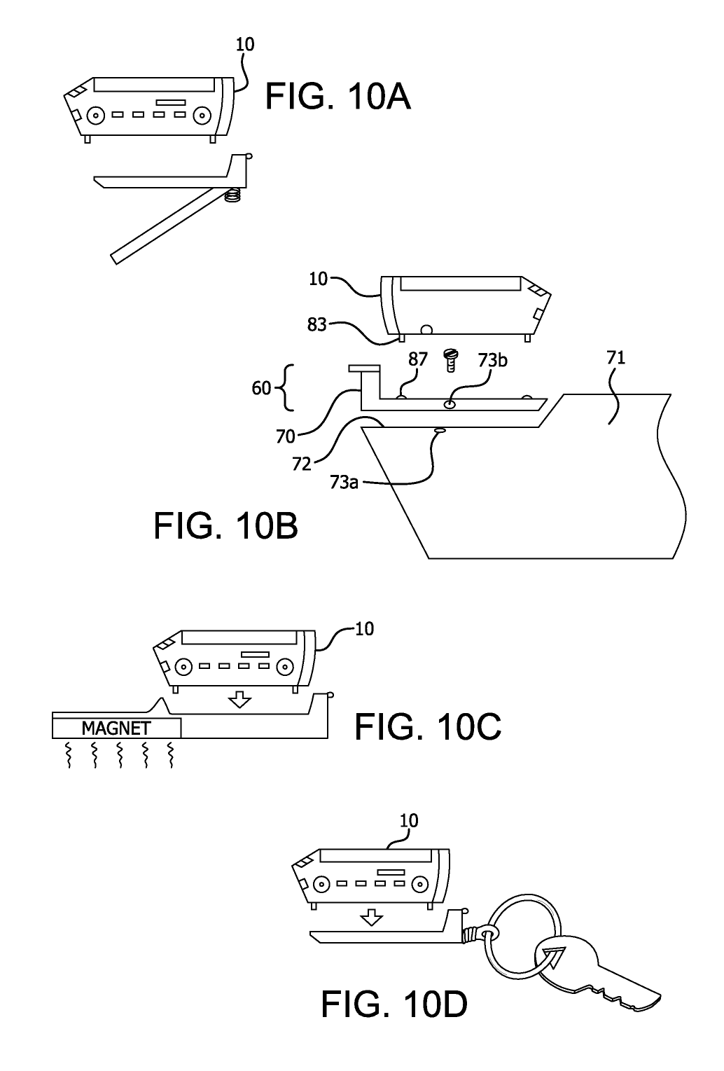

In the hair cutting industry, a consideration in the choice of mounting system is the design and features of the hair clipper selected. A preferred hair clipper for use in connection with the computer devices provided herein is one that is commonly used by professional hair cutting businesses, such as those made by Oster and other manufacturers. One presently preferred hair clipper type is the OSTER Model 76 and related models. Such clippers typically feature removable cutting blades that can be resharpened, and more importantly for present purposes feature a removable backplate, which serves to allow access for certain repairs, maintenance, or service, as well as to provide a location for certain attachments such as a vacuum attachment. The clipper backplate is generally attached with a pair of flush-mounted screws that can be removed and readily replaced. The inventor has discovered that various mountings can be configured to fit the back of this type of hair clipper precisely where the backplate screws to the clipper body; i.e., by removing the backplate, and using the screw holes and optionally the screws to attach the mounting system or a mounting member. (See e.g. FIG. 10, Panel B)

The multimedia device can also be detachably mounted to a variety of different mounts using a variety of different structures in the mounting system. In preferred embodiments, the multimedia device can be conveniently mounted in a detachable manner to a tool used by a professional while providing a personal service to a client (see e.g. FIG. 7). The multimedia device is mounted so that it does not interfere with the normal use of the tool by the professional. As discussed above, in the hair cutting industry the tool is preferably a hair clipper, and more preferably one having a removable back plate as discussed above and depicted in FIG. 10, Panel B.

In other embodiments, the multimedia device can be detachably mounted to a clip-on mount for clipping the multimedia device to an article of clothing, a viewing surface (e.g. a countertop, mirror, furniture, or the like); a handle, including a dedicated handle or a tool that has a handle; a key chain, clip-on mount, a suction cup, a gooseneck mount, or a flexible joint mount or other useful or convenient mount.

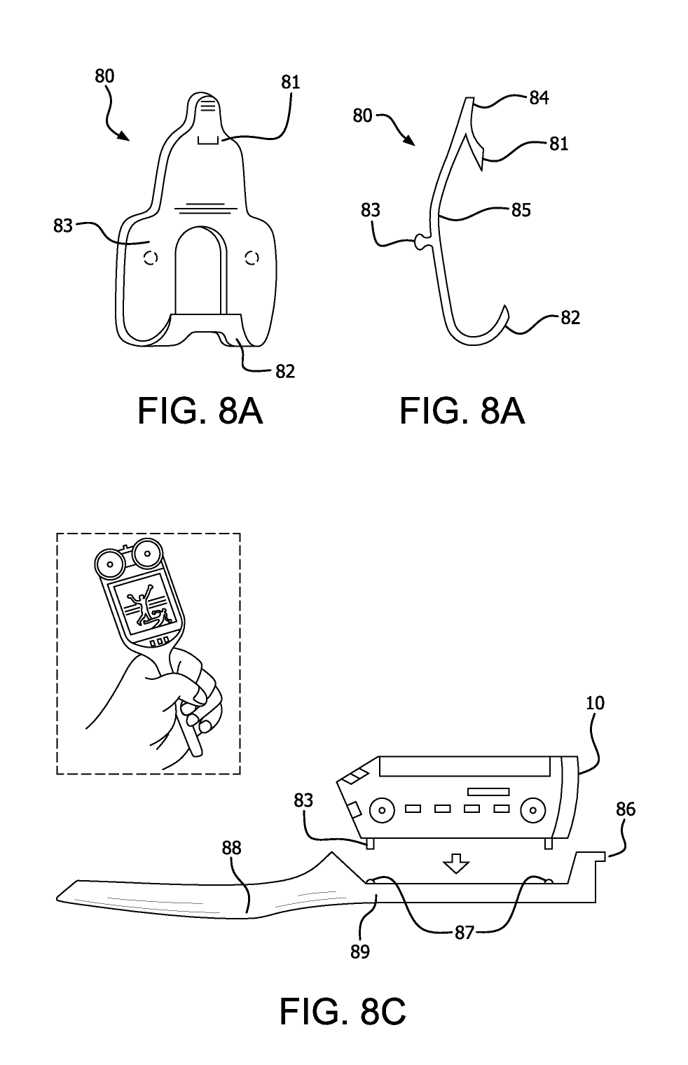

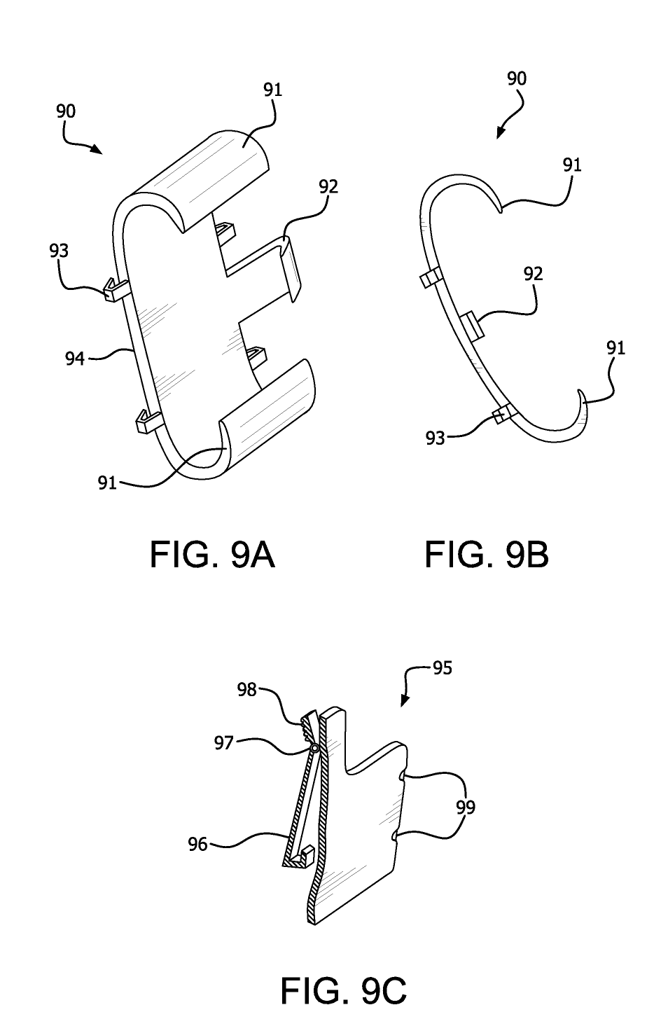

In various presently preferred embodiments, the mounting system comprises two sets of inter-engageable members, one set of which remains connected to the clipper, e.g. with screws, while the other member can be attached and detached quickly and easily at any time, without any disruption to the operation of the computer device, and without the use of any tools. FIG. 7 shows one embodiment of a mounting system (60) for use in the hair cutting industry. The mounting system (60) as shown is adapted for mounting a multimedia media device as provided herein to a mounting receiver that is a hair clipping device (71) (Panel A), and in particular to a clipper where the backplate (72) attaches to the hair clipper (71). The backplate (72) is removed by removing the screws holding it to the clipper (71) from the screw holes (73a). The detachable mounting member (70) (shown in Panel B) comprises a plate with one or more slots (74) therethrough. The mounting member (70) is attached securely but removably to the hair clipper, for example via screws through screw holes (73b) into screw holes (73a) on the hair clipper. The one or more slots (74) correspond to for example, L-shaped finger members (76) on the second part or mounting component/device retaining member (75) (see Panel C) which is attached securely but removably to the multimedia device. The retaining member (75) can be attached by any convenient means to the multimedia device, for example using screws through screw holes (77) which the multimedia device is adapted to receive. The skilled artisan will appreciate that there are a vast number of methods for attaching the device and the retaining member (e.g. see below, and FIGS. 8-9). A related embodiment is presented in FIG. 10B.

The slot(s) (74) of the mounting member (70) are adapted to receive the L-shaped finger members (76) of the retaining member (75) in a neutral position. The L-shaped fingers members (76) of the retaining member (75) can then be slidingly engaged with the mounting member (70) by moving the multimedia device to an engaged position, thereby attaching the multimedia device to the hair clipper (71). The multimedia device fits securely and does not interfere with the operation of the hair clipper, and the display screen of the multimedia device faces the operator.

The multimedia device can also be readily disengaged from the hair clippers in this arrangement by simply sliding the device (and thus the attached retaining member (75) with the L-shaped finger members (76)) from the engaged position to the neutral position and removing the device from the back of the clippers.

The mounting system is not limited to the embodiments depicted. The skilled artisan will also appreciate that the depicted embodiment is just an exemplary configuration, and that the geometric shape of the slots and/or engaging members may vary, and there is no preference at present as to whether the retaining member (75) has protruding engaging members such as the fingers (76), and the mounting member (70) is adapted to receive them, or vice versa.

In another embodiment, as described above, the mounting member (70) of the mounting remains connected to the clipper, the detachable retaining member (75) of the mounting remains removably connected to the multimedia device during normal use. Preferably, the detachable retaining member portion of the mounting in such embodiments allows the multimedia device to charge without removal of the second portion, e.g. when placed in a suitable charging station or cradle. Thus, in preferred embodiments, the multimedia device can be conveniently charged and replaced quickly on the clippers without removing the mounting member, e.g. the retaining member (75).

Moreover, in regular use, the multimedia device can be readily or routinely removed from the clippers without tools and placed in a different mounting for the convenience of the client or the professional. For example, as will be described below, a separate mounting member can include a clip-on apparatus so that when not attached to the hair clipper, the multimedia device can be conveniently clipped onto, for example, a piece of clothing. Thus, a barber could clip the multimedia device having this type of mounting to his shirt pocket, or to an apron or belt for a client, or clip the device to an article of clothing or other surface for the client's enjoyment. In various embodiments, the mounting receiver comprises a mounting member such as a clip-on mount, a suction cup mount, a gooseneck mount, a flexible joint mount, a key ring, a magnetic mount, or a handle (e.g. to be handed to a client) for viewing, listening, or reading, or the like. The multimedia device can be just as readily removed from any of these mounts and replaced on the mounting member (70) for remounting to the clippers (71). In this manner, a single mounting system with universal features is created, and described more generally below.

One highly useful feature of the mounting system provided herein is that using a single retaining member, or a single style of retaining member, the device can be conveniently attached to/connected with a variety of mounting members so that an individual multimedia device can be readily mounted on a tool (e.g. hair clipper) used by the service provider, then subsequently removed from the tool and mounted on a handle for use by a client, then later mounted on an irregular-shaped object (such as the arm of a chair), and still later attached via suction cup to a mirror or a work surface, and later yet mounted on the service provider's key chain or clipped to a belt for transport to another client location or home, for example. This universal mounting system is highly flexible and convenient for the users of the multimedia device.

As can be seen, the mounting system requires attaching of two types. In the first, the multimedia media device is attached to the mounting system or a portion thereof which retains the device. This is generally part of the mounting system referred to as the retaining member. The second comprises attachment of the retaining member to a mounting member which facilitates mounting the device to an object or location. The mounting member can comprise any of a clip-on device, a suction cup, a key ring, a magnetic mount, a gooseneck mount, a flexible joint mount, a handle, or the like, depending on the nature of the services being rendered, the needs of the client or service provider, the physical environment in which the multimedia device is to be mounted, and so on.

The mounting system in one embodiment comprises both a retaining member and mounting member as two parts of a unitary mounting system. In such embodiments the digital device can still be readily moved from one mount to another without the use of tools. As described above, the multimedia device can be placed in a mounting to connect to a tool (e.g. a hair clipper) used by the professional. The device can then be readily removed and placed in a mounting to connect to a handle, or a suction cup mount, clip-on mount, gooseneck mount, flexible joint mount, magnetic mount or the like.

More preferably, the mounting system comprises separate retaining member and mounting member wherein the two members can be readily attached or connected to each other using any convenient means, for example using snaps, clips, inter-engageable members. In such embodiments, the multimedia device can be placed in a retaining member and the retaining member can be attached to any of a family of mounting members comprising different attachments.

As described above, FIG. 7 shows a two-part mounting system with inter-engageable members to connect the retaining member (75) and the mounting member (70). Instead of being adapted for mounting to the the clippers, the mounting member (70) can be adapted for mounting to a handle, a suction cup, a clip-on device, a magnetic mount, a gooseneck mount, a flexible joint mount, or other mount.

Another embodiment having separate retaining member and mounting member, is depicted in FIG. 8. In this embodiment, the retaining member (80) (Panel A) comprises a clip-in feature that retains the multimedia device. The clip (81) is adapted to secure the multimedia device (not shown) by applying sufficient pressure or tension to hold the device in the retaining loop (82). The body of the multimedia device is adapted to receive the clip by having a corresponding slot or the like in which the clip (81) fits. As seen in Panel B, the clip can be released by applying pressure to lever (84). The clip-in mounting system can be aided by selection of proper material (e.g. various plastics) that can provide suitable flexibility and memory, and by designing the retaining member (80) to include a spring-like curve (85) or bend to increase the tension provided by the clip (81). Such clip-in mounts are known in the art for holding cell phones, pagers, walkie-talkies, and the like. The present mount differs in that it comprises attachments (83) for attaching the clip-in retaining member (80) to a mounting member (86) (Panel C) having corresponding or complementary structure (87) to receive the attachments (83). As depicted, the retaining member (80) can removably snap into a corresponding mounting member (not shown) by engaging the snap attachments (83) into suitable receiving holes (87) on the mounting member (86).The mounting member (86) depicted is a dedicated handle having a comfortable handle (88) and a mounting/viewing head (89) optionally comprising a hinged, and/or rotating connection (not shown) to the handle (88). Again, a family or such mounting members can be envisioned including handles, clip-on mounts, gooseneck mounts, flexible joint mounts, magnetic mounts, key rings and the like. The manner in which the retaining member and the mounting member attach can vary widely, and may include inter-engageable parts, snaps (depicted), clips, for example. The skilled artisan will understand how to construct the attachments (83) and the corresponding receiving structure (87) depending on whether snaps, clips, inter-engageable parts or the like are selected.

With further reference to the figures, FIG. 9 shows a further embodiment of the mounting system. Mounting system (90) comprises a retaining member (91) with upper and lower frictional retaining loops (92). The frictional retaining loops (92), of which there may be any number, are made of a material that is sufficiently flexible to apply tension adequate to secure the multimedia device and allow the device to readily removed. Moreover, the design of the retaining loops is generally such that a spring-like curve provides proper tension. Various plastics can be used to make the retaining member (90). Also shown is the side retaining loop (93) which helps prevent the multimedia device from sliding out when not intended. Side retaining loop (93) may or may not provide further frictional holding tension to secure the device. The retaining member (90) may also include one or more additional securing clips, retaining features or the like (not shown) to secure the multimedia device or prevent it from sliding out. The retaining member (90) also features retaining clips (93) oriented to secure the retaining member (90) to a mounting member (Panel C) adapted to be clipped to the retaining member (90). The mounting member (95) comprises a device clip (96) for clipping the device to objects, clothing, etc. The device clip (96) includes hinge point (97) and release lever (98) for opening and releasing the clip (96). The mounting member (95) also features points (99) adapted to receive the retaining clips (93) of the retaining member (90) whereby the retaining member (90) and the mounting member (95) are connected or attached. A family of such mounting members can be developed as described above for other mountings.

FIG. 10 shows a family of mounts of the type described herein in use. The mounting members shown include a clip-on apparatus (Panel A); a hair clipper (Panel B, representative of a tool used in the profession); a magnetic mount (Panel C); and a key ring (Panel D). Such a family of mounts can further include goose neck mounts, flexible joint mounts, and other types of mounts useful for attaching the multimedia device.

While the computer product/multimedia device has been described above in terms of various aspects and embodiments, the method of using that multimedia device is now described in more detail.

Thus, in another aspect of the invention, methods are provided for interacting with a client in a personal services industry, such as the hair cutting industry and in particular, a hair cutting establishment. The methods generally comprise the steps of accessing at least one electronic media file on a portable multimedia device detachably mounted to a retaining member, and playing or displaying the electronic media file for the client. The retaining member is adapted to attach to a mounting member, which can comprise mounting to a hair cutting tool, for example a hair clipper, or a clip-on mount, a handle, a key ring, a suction cup, a gooseneck mount, a flexible joint mount, a magnetic mount, or the like.

In various embodiments, the portable multimedia device can be shown to the client while it is still attached to the hair cutting tool, or the device can be detached from e.g. the hair clippers, and mounted or attached to another mounting member, such as a handle, clip-on device, suction cup, key ring, gooseneck mount, flexible joint mount, magnetic mount or, while not presently preferred by the inventor, even handed directly to the client for viewing.

Generally, the electronic media file is for determining or designing a suitable hair cut or style, or for entertainment purposes. In one embodiment, the methods further comprise selecting the electronic media file based on at least one preference of the client. For example, if a client has a preference for a certain type of hair style, such as a razor cut, the electronic media file may contain photos of various designs for razor-type hair cuts, or even videos of people, such as sport figures or celebrities with styles similar to those of interest or potential interest to the client. Alternatively, the electronic media file could be a college football video clip of the client's favorite team or favorite player, or favorite breed of dog.

In one embodiment, the barber can ask the client about a preference and subsequently access the select the electronic media file based on the response. In a preferred embodiment however, the preference has previously been entered into a database in the portable multimedia device and the database entry is associated with that client. In such cases, the preferences are stored in the multimedia device until the client's next visit to the shop or salon, or until the preferences are updated.

In yet another aspect of the invention, methods are provided for improving client relationships in a hair cutting establishment comprising the steps of:

(a) creating a database of client data for a plurality of clients including, for each client:
(1) at least one client identifier and at least one client preference for hair cut or hair style, and
(2) optionally, other client data including
   (i) preference data for one or more of music genres, celebrities, videos, sports, sports teams, athletes, hobbies, cars, foods, books, movies, and/or pets, and
   (ii) personal data including one or more of birthdate, anniversary, family members, nickname, Zodiac sign, occupation, employer, colleges, military service and the like;

(b) creating a library of electronic media files comprising one or more of photographs, music, videos, documents (e.g. articles), and books;

(c) associating at least one electronic media file from the library with at least a first client; and

(d) accessing the database to make the electronic media file available to the first client when the first client next visits the hair cutting establishment; wherein the database is stored in and the media file is displayed on a portable multimedia device detachably mounted to hair cutting tool such as a hair clipper.

In preferred embodiments, the hair cutting tool is a hair clipper.

In some embodiments, the methods the associating step includes associating at least one electronic media file with each of the plurality of clients.

The portable multimedia device preferably comprises a color display screen. In some preferred embodiments, the device also includes at least a camera, and a light, particularly an LED that is capable of helping to illuminate the work area (i.e the hair and scalp of the client whose hair is being cut or styled).

One particularly advantageous aspect of the methods is the ability of the barber to use the multimedia device while it is attached to the clippers, and also to be be able to detach to the device and hand it to the client or use a clip-on mounting to clip the device to the client, an apron, belt or other location for viewing or listening by the client. The methods therefor further comprise the step of detaching the portable multimedia device from the hair clipper for use by the client, for example by attaching the device to a handle and providing to the client. This allows the client to listen to or view the device, and may optionally allow the client to control the device. In such methods, the device may have a Security Module such that the client can only access certain files or menus and may not intentionally or accidentally alter or delete information or files, and may not access other clients' personal or contact information.

Generally, one or more of the creating steps, e.g. creating the database entries for clients, and/or creating the media library, can be performed by connecting the device to a personal computer, tablet computer, smart phone, or the like.

All of the foregoing methods of using the device generally provide several advantages, such as improved communication with clients, improved client relationships, and improved business management tools. Clients can be entertained using the device, system and methods described herein and will tend to visit the shop or salon more frequently and/or reward the barber or stylist with better gratuities. Improved job satisfaction may also result for the barber or stylist as a result of feeling more connected with the client's.

In general use, the multimedia device is a tool for the shop or salon owner to improve his business by providing more personalized service to clients. The device allows the barber or stylist to enter and store data about his or her clients including data about the client's hair cutting and styling preferences as well as data about the client's likes and dislikes. In one embodiment, the methods include a step of creating at least one data entry about a client's hair cut or hair style preferences. Such methods also include the step of creating a library or database of electronic media files, based at least in part on client preferences

The multimedia device may also be used for other applications, and additional applications can preferably be downloaded from, for example, a network providing such applications (e.g. via an internet connection) and readily installed by the user. Examples of such applications include accounting and tax applications, e.g. income and expense tracking, tracking client trends, obtaining news or information about the hair cutting industry, news or information related to a client preference, or general news or information. The device may be useful for communicating with suppliers, who may have interest in providing such resources to barber shops or salons in the course of business as a promotional tool for their own goods. The device can also be used as a promotional tool by the shops or salons, for example by including advertisements or advertorial information viewable by clients, useful or entertaining screen savers (e.g. a traditional barber pole) for display, or special coupons, offers, or codes for regular clients.

Because the frequency with which clients visit the professional may vary widely, the ability of the professional to immediately recognize the client may vary from client to client and professional to professional. In some embodiments, the methods can include providing the client with unique identifying information, for example a bar code or RFID tag, or the like wherein when a client visits the professional, the bar code or RFID tag may be scanned to track the client's visits, and help update the client's preferences. Moreover, scanning the bar code, tag, or other identifier will also serve to identify the client to the professional, thus refreshing the recall of the professional with respect to a client who visits only infrequently. For such embodiments, the device (10) may include a scanning module for scanning/reading the bar code, RFID, or other identifier assigned to each client. The methods thus would include providing a client with such a unique identifier, and associating the client's data with the unique identifier provided to the client, and on subsequent visits, reading the unique identifier and accessing the client's data associated therewith. Many retailers now use such bar codes to identify regular or preferred customers, to offer additional privileges or advantages, such as preferred pricing, discounts, or rewards based on frequency or longevity, and to track client activity for marketing purposes. Thus, the skilled artisan will be familiar with adapting such technology with the invention disclosed herein. The bar code, RFID tag, or other ID can itself provide advertising by featuring information (e.g. location, phone number, and/or website) about the business or professional.

In another aspect of the invention, kits are provided. Generally the kits comprise a portable multimedia device as described herein above, a suitable mounting for detachably mounting the device to a hair clippers, and hair clippers to which the device can be mounted. Optionally, the kits include instructions for use of the device, and suggestions for improving relationships with clients in the hair cutting industry, particularly though use of the multimedia device. The instructions may be provided on paper, CD-ROM, USB ‘thumb drive’ or other removable storage device or the like. The kits may further comprise software, drivers, or the like packaged with the hardware, or made available for download. The kits may include the device and other components together in separate packages or packaged together in a single package. The kits may also include useful or entertaining media files, for example, detailed instructional videos on how to perform certain services such as specialty hair styles or hair cuts, or how to improve customer/ client relationships using the multimedia device, or video or music that is licensed for use in the device.

### EXAMPLES

The invention can be further illustrated by the following examples, although it will be understood that the examples are included merely for purposes of illustration and are not intended to, and do not limit the scope of the invention unless otherwise specifically indicated.

### Example 1

### A New Client

In this hypothetical example, a new client, Alpha, who has not previously entered the barber shop comes for his first visit. The barber introduces himself and begins to provide the services requested, such as providing a hair cut. The barber asks permission to take a photograph of Alpha's haircut and to enter him into the client database. The barber may tell Alpha about the device and briefly explain the advantages and give a brief demonstration of the multimedia functions. The barber asks Alpha a few questions about his preferences about his haircut preferences and optionally in one or more areas of other interests. Alternatively, the barber optionally asks Alpha to fill out a brief questionnaire about his preferences in music, sports, entertainment, and more.

After or providing the services, the barber creates a database entry for Alpha and enters the preference data either directly from the device, or more preferably at a time when the barber is able to connect the device to a personal computer or other device with a full keyboard for example.

### Example 2

### A Repeat Client

In this hypothetical example, a client, Bravo returns to the shop for a second or subsequent visit. The barber quickly pulls up Bravo's data file that was previously entered into the device and prompts his own memory as to Bravo's preferences for hair cuts, and optionally other information or preferences including Bravo's family, employer, and other interests. The barber is then able to quickly access photo's of Bravo's last hair cut and similar cuts to confer with Bravo as to his present wishes for the hair cut, and the barber is able to have a pleasant and natural conversation with Bravo based on the information the barber reviewed.

While the barber is providing the services to Bravo, he is able to access one or more music files or video clips that are likely of interest to Bravo and the barber can then share those with Bravo, for example by handing the device to Bravo with one or more electronic media files selected to run or ready to be selected.

### Example 3

### Pet Groomer

Charlie has a companion dog named Max who requires grooming. Charlie brings Max to a groomer which uses a multimedia device as provided herein. The groomer is able to review the last grooming job for Max and shows Charlie the picture of Max's last grooming and confirms the style and length that Max's coat is to be cut. The groomer works on Max after Charlie leaves. When Max behaves well and cooperates, the groomer uses the device to play sounds of Charlie's voice praising Max and telling him he is a good dog. Upon hearing Charlie's voice, Max reacts in a happy manner and continues his good behavior. The groomer can also play reassuring sounds of charlie's voice from time to time during the grooming to help Max stay calm and relaxed.

### Example 4

### Infrequent Client with Credit Card

A new client visits a barbershop. The barber enters basic data for the client into the multimedia device and provides the client with a bar code and/or RFID tag and associates the unique ID with the client's data. The device is equipped with a suitable reader. Although the barber has only met the client one time, several months later the client returns to the barber and provides his bar code to take advantage of the repeat client program. Upon scanning the ID, the barber immediately has his memory refreshed and is able to welcome the client back by name and indicate that it has been a while since he last visited. After receiving the desired services, the client wishes to pay using his credit card. The device is also equipped with a credit card module and the barber is able to quickly scan the client's credit card and secure payment. The client indicates that he would prefer not to have the barber store his credit card information and the barber therefore processes the charge accordingly and does not store the information for future visits. Upon the client's next visit, the barber can again access the client's service information from the ID card, and if the client choose to pay by credit card for future services, the barber can readily rescan the card.

### Example 5

### Additional Uses

In addition to the foregoing, the multimedia device has a variety of other uses which will be apparent the to the skilled artisan. For example, a repeat client, Delta, comes into the barber shop. The barber determines that Delta wants to change his hair style.

Using the device, the barber is able to access photos of a number of hairstyles of potential interest to Delta and to allow Delta to browse the photos on the device. Delta and the barber are then able to discuss the various options of greatest interest to Delta. Delta can then decide which style to go with.

### Example 7

### Universal Mounting System

An electronic device can be detachably mounted to a retaining member that readily connects to a family of mounting members including for example, a clip-on mount, a suction cup mount, a flexible joint mount, a gooseneck mount, a handle, a key ring, and others. The owner of the device can detachably mount the device to a retaining member and can attach it to a clip-on mount and clips it her purse strap in the morning. Upon arriving at work, she can easily detach the retaining member (and thus, the device) from the clip-on mount and can place the retaining mount into a suction cup mount attached to the side of her computer for use during the day. She later can attach the device to a gooseneck mount for use during a conference call. Still later she uses a flexible joint mount to connect the device to the handrail on the treadmill at the gym after work.

The scope of the invention is set forth in the claims appended hereto, subject, for example, to the limits of language. Although specific terms are employed to describe the invention, those terms are used in a generic and descriptive sense and not for purposes of limitation. Moreover, while certain presently preferred embodiments of the claimed invention have been described herein, those skilled in the art will appreciate that such embodiments are provided by way of example only. In view of the teachings provided herein, certain variations, modifications, and substitutions will occur to those skilled in the art. It is therefore to be understood that the invention may be practiced otherwise than as specifically described, and such ways of practicing the invention are either within the scope of the claims, or equivalent to that which is claimed, and do not depart from the scope and spirit of the invention as claimed.

1. A portable multimedia device for use by a service provider in the personal services industry to improve a client's experience of the services comprising a microprocessor in data communication with a data storage drive, memory sufficient for booting and running an operating system for use on the multimedia device, a display screen, a speaker, and one or more ports that are A/V ports, communication ports, or networking ports, and a power source in electrical communication therewith, and wherein the multimedia device comprises a mounting component adapted for detachably mounting the multimedia device to a mounting receiver.

2. The multimedia device of claim 1 wherein the personal services establishment is a hair cutting business and wherein the mounting receiver comprises: (a) a hair cutting tool, wherein the mounting receiver does not interfere with the hair cutting tool's use and permits use of the multimedia device while the tool is in use; (b) a clip-on mount; (c) a handle; (d) a key ring; (e) a suction cup; (f) a magnetic mount; (g) a gooseneck mount; or (h) a flexible joint mount.

3. The portable multimedia device of claim 1 further comprising one or more of a camera, an audio/voice recorder, an LED, a telephone, a SIM card, a flash memory drive; a USB port, wireless communications, a rechargeable battery, a credit card reader, or a bar code reader.

4. The portable multimedia device of claim 3 wherein the hair cutting tool is hair clippers, the display is a touchscreen, the wireless communications include at least one WAP layer, and the rechargeable battery is a lithium ion battery.

5. The portable multimedia device of claim 2 wherein the mounting component comprises screws, clips, a ‘hooks and loops’ type mounting, a magnet, or a two-part system of inter-engageable members that can be removably attached to the hair clipper in place of a removable plate thereon.

6. The multimedia device of claim 2 wherein the mounting component comprises a two-part system of inter-engageable members wherein the two-part system comprises a mounting member removably attachable to the mounting receiver and a retaining member removably attachable to the multimedia device, and wherein the mounting member and retaining member can be slidingly engaged and disengaged readily with each other without the use of tools.

7. The multimedia device of claim 6 wherein one of the mounting member and retaining member comprises at least one slot adapted to receive, in a neutral position, L-shaped members on the other member, wherein the mounting member and retaining member can be slidingly engaged with each other by sliding the device from the neutral position to an engaged position, thereby attaching the multimedia device to the hair clippers, and wherein in this arrangement the multimedia device can be disengaged from the hair clippers by sliding the device from the engaged position to the neutral position and removing the device from the back of the clippers.

8. The multimedia device of claim 1 further comprising software for an operating system to operate the device, a client relationship management program, and a media library.

9. A method of interacting with a client in a personal services establishment comprising the steps of accessing at least one electronic media file on a portable multimedia device detachably mounted to a mounting receiver and playing or displaying the electronic media file for the client.

10. The method of claim 9 wherein the personal services establishment is a hair cutting establishment and the mounting receiver comprises (a) a hair cutting tool, wherein the mounting receiver does not interfere with the hair cutting tool's use and permits use of the multimedia device while the tool is in use; (b) a clip-on mount; (c) a handle mount; (d) a key ring mount; (e) a suction cup mount; (f) a magnetic mount; (g) a gooseneck mount; or (h) a flexible joint mount.

11. The method of claim 10 wherein the hair cutting tool is hair clippers and the portable multimedia device is detached from the hair clippers and detachably mounted to another mounting receiver or handed to the client.

12. The method of claim 9 further comprising selecting the electronic media file based on at least one preference of the client.

13. The method of claim 12 wherein the preference has previously been entered into a database in the portable multimedia device and the database entry is associated with that client.

14. The method of claim 10 wherein the electronic media file is for determining or designing a suitable hair cut or style, or for entertainment purposes.

15. A method for for improving client relationships in a hair cutting establishment comprising the steps of:
creating a database of client data for a plurality of clients, including for each client:
at least one client identifier and at least one client preference for hair cut or hair style,
and optionally, other client data including
preference data for one or more of music genres, celebrities, videos, sports, sports teams, athletes, hobbies, cars, foods, books, movies, and/or pets, or
personal data including one or more of birthdate, anniversary, family members, nickname, Zodiac sign, occupation, employer, colleges, military service and the like;
creating a library of electronic media files comprising one or more of photographs, music, videos, documents (e.g. articles), and/or books;
associating at least one electronic media file with at least a first client; and
accessing the database to make the electronic media file available to the first client when the first client next visits the hair cutting establishment;
wherein the database is stored in and the media file is displayed on a portable multimedia device detachably mounted to a hair cutting tool.

16. The method of claim 15 wherein the hair cutting tool is a hair clipper.

17. The method of claim 15 wherein the associating step includes associating at least one electronic media file with each of the plurality of clients.

18. The method of claim 15 wherein the portable multimedia device comprises a color display screen, a camera, and a light.

19. The method of claim 16 further comprising the step of detaching the portable multimedia device from the hair clipper and handing the device to the client.

20. The method of claim 15 wherein the creating steps can be performed by connecting the device to a personal computer.

21. A universal mounting system for a portable electronic device comprising a retaining member for retaining the device; and a mounting member for mounting the device to an object or surface; wherein the retaining member and the mounting member are detachably connected, and the mounting member comprises a handle, a clip for clipping the device onto an article, a suction cup, a gooseneck mount, a flexible joint mount, a key ring, or a magnetic mount.

22. The mounting system of claim 21 wherein the device is retained in the retaining member via one or more screws, or clips, or by friction, and the retaining member and the mounting member are attached to each other via inter-engageable members, snaps, or clips.
